(19) United States
(12) Patent Application Publication
(10) Pub. No.: US 2012/0148160 A1
(43) Pub. Date: Jun. 14, 2012

(54) LANDMARK LOCALIZATION FOR FACIAL IMAGERY

(75) Inventors: Gurumurthy Swaminathan, Bangalore (IN); Saad J. Bedros, West St. Paul, MN (US)

(73) Assignee: Honeywell International Inc., Morristown, NJ (US)

(21) Appl. No.: 12/832,613

(22) Filed: Jul. 8, 2010

(51) Int. Cl. G06K 9/46

(52) U.S. Cl. 382/195

(57) ABSTRACT

A process and system for facial landmark detection of a face in a scene of an image includes determining face dimensions from the image, identifying regions of search for one or more facial landmarks using the face dimensions, and running a cascaded classifier and a strong classifier tailored to detect different types of facial landmarks to determine one or more respective locations of the facial landmarks. According to another example embodiment, the facial landmarks are used for face mining or face recognition, and the cascaded classifier is performed using a multi-staged AdaBoost classifier, where detections from multiple stages are utilized to enable the best location of the landmark. According to another example embodiment, the strong classifier is a support vector machine (SVM) classifier with input features processed by a principal component analysis (PCA) of the landmark subimage.

### TECHNICAL FIELD

The present invention relates generally to the field of face detection and recognition. More specifically, the present invention relates to landmark detection and localization of facial imagery.

### BACKGROUND

Surveillance systems are being used with increasing frequency to detect and track individuals within an environment. In security applications, for example, such systems are often employed to detect and track individuals entering or leaving a building facility or security gate, or to monitor individuals within a store, hospital, museum or other such location where the health and/or safety of the occupants may be of concern. More recent trends in the art have focused on the use of facial detection and tracking methods to determine the identity of individuals located within a field of view. In the aviation industry, for example, such systems have been installed in airports to acquire a facial scan of individuals as they pass through various security checkpoints, which are then compared against images contained in a facial image database to determine if the individual is on a watch list. While face recognition-based security is an ever more useful tool for law enforcement and other applications, the proper recognition of faces in an image, particularly where there are many faces in the image at varying angles to the camera, remains a difficult technical challenge. Detecting landmarks such as eyes, nose and mouth supports the alignment of the facial images for a robust face recognition.

### BRIEF DESCRIPTION OF THE DRAWINGS

The accompanying figures, in which like reference numerals refer to identical or functionally-similar elements throughout the separate views and which are incorporated in and form a part of the specification, further illustrate the present technology and, together with the detailed description of the technology, serve to explain the principles of the present technology.

FIG. 1 is a flow chart of a process (and?) software for facial landmark localization and deletion according to the present technology.

FIG. 2 is a diagrammatic view of a facial detection and tracking system in accordance with the present technology.

FIG. 3 is a flow chart of a process and software for facial landmark localization and deletion according to the present technology.

FIG. 4 is a system diagram of an example computing system used in the present technology.

### DETAILED DESCRIPTION

The following description should be read with reference to the drawings, in which like elements in different drawings are numbered in like fashion. The drawings, which are not necessarily to scale, depict illustrative embodiments and are not intended to limit the scope of the invention. Although examples of various steps are illustrated in the various views, those skilled in the art will recognize that the many of the examples provided have suitable alternatives that can be utilized. Moreover, while several illustrative applications are described throughout the disclosure, it should be understood that the present invention could be employed in other applications where facial detection and tracking is desired.

The landmark detection technology described herein provides methods and systems for detecting landmarks on a face in an image. Detection of landmarks helps in aligning faces for further analysis which in turn can increase the recognition rate of face recognition algorithms. In particular, the present technology detects landmarks such as eyes, nose and mouth of the face in spite of various illumination variations, in-plane and out-of-plane rotations. One feature of the technology is to associate people across cameras in large facilities, wherein face alignment of the captured images increases the performance of the recognition or association.

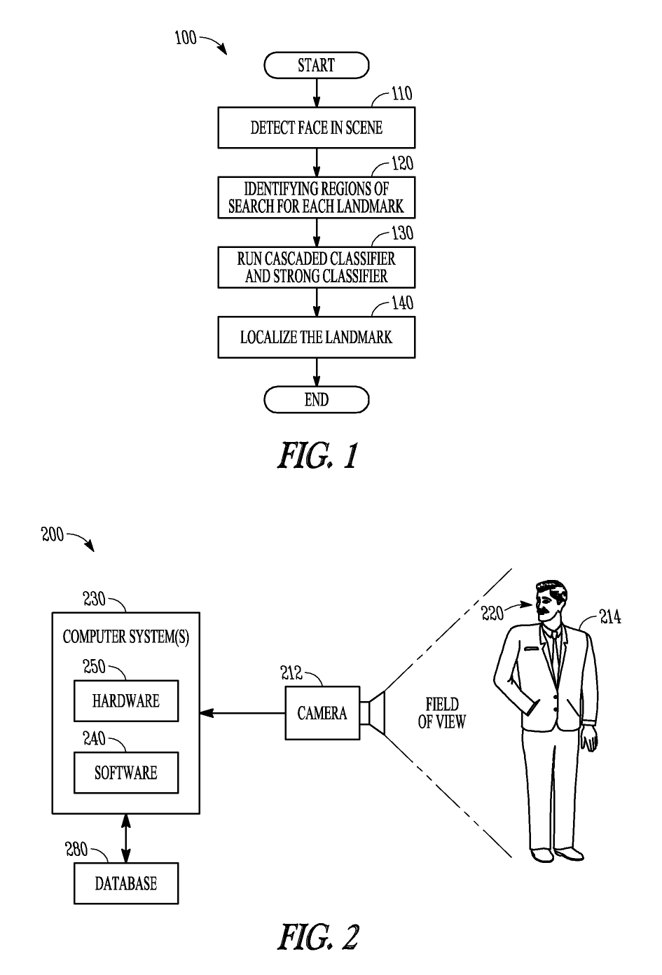

As described in more detail below and as shown in high-level form FIG. 1, the technology 100 provides, in one example embodiment, for: detecting the face in a scene of an image (110), identifying regions of search for each facial landmark using the detected face dimensions (120), running a cascaded classifier and a strong classifier tailored detector on each landmark to obtain the location of the landmark (130), and preprocessing of the detected information to determine or localize the landmark (140). This process can be applied for face mining and face recognition applications. According to one example embodiment, the use of an adaptive boosting (AdaBoost) and support vector machine (SVM) detector helps in obtaining more localized detections of the landmark. The use of output from multiple stages of AdaBoost depending on the image is unique and helps in achieving rates of detection. The use of surface fitting on the SVM detections also helps in better localization. AdaBoost is a machine learning algorithm, and in particular a meta-algorithm that can be used in conjunction with many other learning algorithms to improve their performance. AdaBoost is adaptive in the sense that subsequent classifiers built are tweaked in favor of those instances misclassified by previous classifiers. Further, the SVMs are a set of related supervised learning methods used for classification and regression.

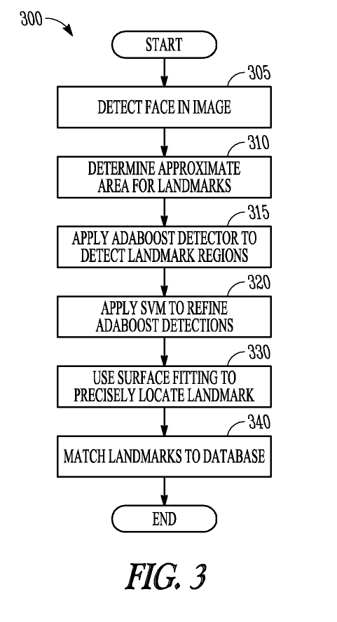

According to one example embodiment, the landmark detection technology hereof may be used in facial detection and tracking system 200 such as that illustrated in FIG. 2. System 200 employs a digital camera 212 to detect and track an individual 214 located within a field of view. In one embodiment, camera 212 may be a pan tilt zoom camera. The PTZ camera can be configured to pan and/or tilt in a direction towards the individual's face 220 and initiate an optical-zoom or telephoto mode, wherein the PTZ camera 212 zooms-in on the area surrounding the individual's face 220. In certain designs, for example, the PTZ camera can include a vari-focus optical lens that can be adjusted to concentrate the PTZ camera on a particular space within the wide field of view in order to provide a higher-resolution image of the face 220 (or of multiple faces 220 in the field of view) sufficient to perform facial recognition of the individual 214. In other designs, digital techniques can also be employed to adjust the resolution of the PTZ camera, such as, for example, by altering the resolution of a charge coupled device (CCD) or other such image array within the camera 212.

The camera 212 can be operatively connected to one or more computer systems 230 or other suitable logic devices for analyzing and processing images that can be used to facially recognize each tracked individual. The computer system 230 can include software 240 and/or hardware 250 that can be used to run one or more routines and/or algorithms therein for controlling and coordinating the operation of the cameras in a desired manner. A monitor, screen or other suitable display means 250 can also be provided to display images acquired from the camera 212. According to one embodiment, software 240 includes face detection software including one or more modules, objects or routines to perform the landmark detection process described herein. In addition, software 240 also includes face recognition capabilities to match detected facial features and in turn faces of subjects to one or more subjects represented in a database 280 of known faces and subjects accessible by computer system 230.

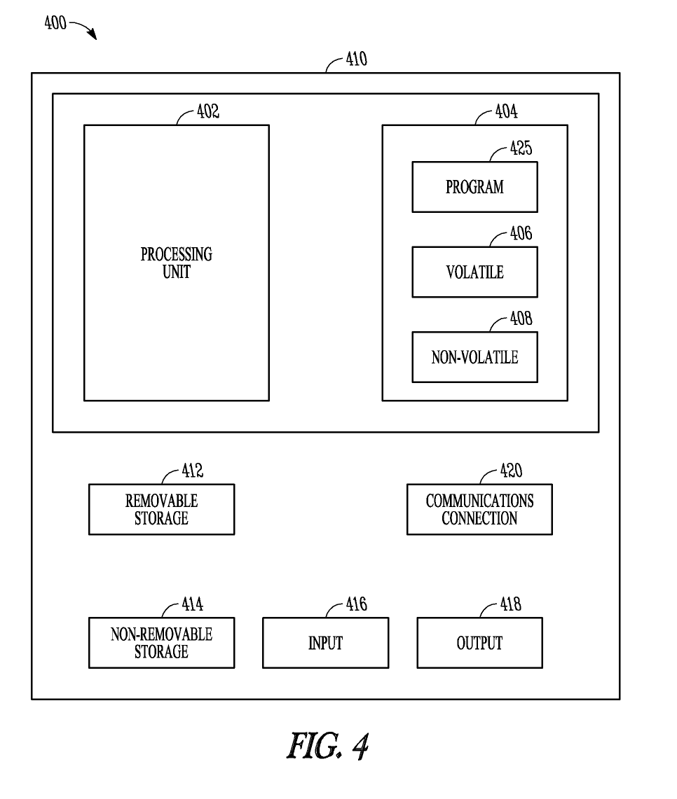

Referring now to FIG. 3, there is illustrated an example embodiment 300 of a process for face detection according to the present technology wherein the landmark detector uses a two-stage approach for localizing the landmarks. Process 300 is also representative of the flow of software used to implement the process. First, the face is detected in the image using a face detector (305). Next, the approximate area for the landmark is calculated based on the size of the face (310) to determine a probable landmark area. An AdaBoost based detector is then applied within the probable landmark area (alternately referred to as the landmark subimage) to detect possible regions for the landmark (315). These AdaBoost detections are further refined by a SVM post-processor (320). More particularly, each AdaBoost detection is run through a principal component analysis (PCA) transformation and a feature vector is generated for the SVM classification. In addition, a distance value from the sum classification is generated. Finally, a surface fitting on the distance values of the SVM output is use to precisely localize the landmark (330). More specifically, the surface is fit using a Gaussian kernel using the distance value from SVM and the peak of the output is selected as the final output. The same approach is used to detect all the landmarks. Optionally, the method 300 may match the face to a database of known subjects (340).

In one embodiment, the classifiers used are trained for each particular type of landmark, for example one classifier trained for eyes, one trained for noses, and one trained for mouths. According to one example embodiment, the method detects four landmarks (two eyes, nose and mouth) on the face, however fewer or more landmarks may be detected.

According to another example embodiment, the AdaBoost detector is trained with positive and negative samples of the landmark that needs to be detected. In this embodiment, offline data is generated using standard datasets and is used to train the AdaBoost detector. However, any acceptable method for training the detector may be used. The AdaBoost detector typically outputs multiple detections per landmark, but sometimes there are no detections for a particular landmark. This may be due to the orientation of the face or illumination variances on the face. In such cases, the stage of AdaBoost that has multiple detections (for example a minimum of 3, although the minimum may be fewer or greater) is chosen as the final stage and the detections (output) of that stage is used as the final output. This choice is based at least in part on the assumption that the face is detected correctly and hence the landmark is sure to be present in the face. According to one example embodiment, the detector is used for the frontal faces where all landmarks are present.

As indicated above, the output of the AdaBoost detector is then used as input to the SVM model. The SVM is trained on the principal component analysis (PCA) features of the training images. The AdaBoost detector output is transformed using the PCA vectors and then fed to SVM. The SVM output is then used to obtain the final localized output.

According to another example embodiment, the input features of the subimage include multiscale Difference of Gaussian (DoG) subimage features. In another embodiment, the system and method provide for the use of PCA subspace on the landmark subimage and/or DoG features extracted from the AdaBoost detections before feeding it to SVM. According to still another example embodiment, an Active Appearance Model (AAM?) is used for selecting the best landmarks out of a set of detections, wherein the AAM is a computer vision algorithm for matching a statistical model of object shape and appearance to a new image, as well known in the art.

According to one example embodiment, the training of the SVM model is done using positive and negative samples. These samples are generated by running the AdaBoost detector on the training data (training data of the AdaBoost) and then classifying the detections as a positive or negative sample. In one example implementation, detection is classified as a positive sample if the center of the detection is within a certain distance (N) from the ground truth location. These positive samples are used to generate a principal component analysis (PCA) subspace onto which both the positive and negative samples are projected. The projected vectors are then used to train the SVM.

In another example embodiment, during testing the AdaBoost detections for a landmark is run through the PCA transformation to generate the input vector for the SVM classifier. The input vector is then fed to the SVM classifier to generate the distance value for that particular detection. A surface is fitted based on the distance value using kernel density estimation and using a Gaussian kernel. The peak of the surface is found by evaluating the kernel at all paces inside the search area and then used as the final output.

As illustrated in FIG. 4, an example embodiment 400 of the controller 312 is illustrated. System 400 executes programming for implementing the above-described process 300 under software control using, for example, one or more computer programs 425 shown stored, at least in part, in memory 404. According to one embodiment, the processes 300 are implemented as software modules on the system 400. A general computing device in the form of a computer 410 may include a processing unit 402, memory 404, removable storage 412, and non-removable storage 414. Memory 404 may include volatile memory 406 and non-volatile memory 408. Computer 410 may include—or have access to a computing environment that includes—a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other tangible and physical medium capable of storing computer-readable instructions. Computer 410 may include or have access to a computing environment that includes input 416, output 418, and a communication connection 420. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks. Computer-readable instructions stored on a tangible and physical computer-readable medium in a non-transitory form are executable by the processing unit 402 of the computer 410. A hard drive, CD-ROM, and RAM are some examples of articles including a computer-readable medium.

Having thus described the several embodiments of the present invention, those of skill in the art will readily appreciate that other embodiments may be made and used which fall within the scope of the claims attached hereto. Numerous advantages of the invention covered by this document have been set forth in the foregoing description. It will be understood that this disclosure is, in many respects, only illustrative. Changes can be made with respect to various elements described herein without exceeding the scope of the invention.

What is claimed is:

1. A process for facial landmark detection, comprising:
detecting a face in a scene of an image;
determining face dimensions from the image;
identifying regions of search for one or more facial landmarks using the face dimensions; and
running a cascaded classifier and a strong classifier tailored to detect different types of facial landmarks to determine one or more respective locations of the facial landmarks.

2. A process according to claim 1 further including using the facial landmarks for face mining or face recognition.

3. A process according to claim 1 further wherein the cascaded classifier is performed using a multi staged AdaBoost classifier, where detections from multiple stages are utilized to enable the best location of the landmark.

4. A process according to claim 1 further wherein the process of facial landmark detection is based on the output of all of the cascaded stages of the AdaBoost classifier.

5. A process according to claim 1 further wherein the strong classifier is a support vector machine (SVM) classifier with input features of a landmark subimage.

6. A process according to claim 5 further wherein the input features of the subimage include multiscale Difference of Gaussian subimage features.

7. A process according to claim 4 further including the use of PCA subspace on the landmark subimage and/or Difference of Gaussian features extracted from the AdaBoost detections before supplying it to the SVM.

8. A process according to claim 1 further including performing spatial interpolation on SVM detections.

9. A process according to claim 1 further including performing geometrical landmark constraints for selecting the best landmarks out of a set of detections.

10. A process according to claim 1 further wherein the landmark constraints are selected from the group: distance between the eyes, nose, and mouth.

11. A process according to claim 1 further including use of an Active Appearance Model for selecting the best landmarks out of a set of detections.

12. A computer program product comprising a tangible, non-transitory storage medium having stored thereon a machine-readable computer program including instructions operable when executed on a computing platform to
a) detect a face in a scene of an image;
b) determine face dimensions from the image;
c) identify regions of search for one or more facial landmarks using the face dimensions; and
d) run a cascaded classifier and a strong classifier tailored to detect different types of facial landmarks to determine one or more respective locations of the facial landmarks.

13. A product according to claim 12 further wherein the computer program includes instructions that when executed use the facial landmarks for face mining or face recognition.

14. A product according to claim 12 further wherein the cascaded classifier is performed using a multi staged AdaBoost classifier, where detections from multiple stages are utilized to enable the best location of the landmark.

15. A process according to claim 12 further wherein the strong classifier is a support vector machine (SVM) classifier with input features of a landmark subimage.

16. A process according to claim 12 further wherein the input features of the subimage include multiscale Difference of Gaussian subimage features.

17. A process according to claim 12 further including computer instructions that provide for the use of PCA subspace on the landmark subimage and/or Difference of Gaussian features extracted from the AdaBoost detections before supplying it to the SVM.

18. A process according to claim 12 further including computer instructions to perform spatial interpolation on SVM detections.

19. A process according to claim 12 further including computer instructions to perform in geometrical landmark constraints for selecting the best landmarks out of a set of detections.
